(19) United States
(12) Patent Application Publication
(10) Pub. No.: US 2022/0108192 A1
(43) Pub. Date: Apr. 7, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Qian ZHANG, Kanagawa (JP); Masahiro SATO, Kanagawa (JP); Takashi SONODA, Kanagawa (JP); Tomoko OHKUMA, Kanagawa (JP)

(73) Assignee: FUJIFILM Business Innovation Corp., Tokyo (JP)

(21) Appl. No.: 17/315,528

(22) Filed: May 10, 2021

(30) Foreign Application Priority Data
Oct. 5, 2020 (JP) 2020-168761

(51) Int. Cl. G06N 5/04; G06K 9/62; G06F 11/34

(52) U.S. Cl. CPC G06N 5/04; G06F 11/3438; G06K 9/623; G06K 9/6215

(57) ABSTRACT

An information processing apparatus includes: a processor configured to: search first action histories for second action histories similar to a specific action history of a second user to whom a recommendation is to be provided, in which each first action history represents objects which a first user corresponding to the first action history took a specific action for and each of which a degree of preference of the corresponding first user is given, and the specific action history represents objects which the second user took the specific action for; select an object to be recommended to the second user based on the degrees of preference for the respective objects which are given to the respective second action histories; and present the selected object.

### CROSS-REFERENCE TO RELATED APPLICATIONS

This application is based on and claims priority under 35 USC 119 from Japanese Patent Application No. 2020-168761 filed Oct. 5, 2020.

### BACKGROUND

### (i) Technical Field

The present disclosure relates to an information processing apparatus and a non-transitory computer readable medium.

### (ii) Related Art

JP-A-2008-244602 discloses a technique including a unit that allows viewers to input evaluations (Good or No-Good) of broadcast program information according to preferences of the viewers, a unit that allows the viewers to input evaluations of a genre list common to the viewers, a first aggregation unit that acquires, for each broadcast program, an evaluation of the common genre list which each viewer of viewers who are viewing the same program has input over the network, and aggregates the acquired evaluations, a second aggregation unit that aggregates, for each broadcast program, evaluations according to the preferences of the viewers over the network and aggregates the acquired evaluations, and a display that displays the evaluation of each broadcast program aggregated by the first and second aggregation units.

JP-B-6566515 discloses a technique including a rating matrix storing unit, a first similarity calculating unit, a first neighbor data extracting unit, a first rating predicting unit, and an item recommending unit. The rating matrix storing unit stores a rating matrix in which ratings, on items, of users are entered. The first similarity calculating unit calculates a similarity between the users using a similarity measure that prevents a hub from appearing. The first neighbor data extracting unit extracts k users in descending order of a similarity to a target user from the top, using the similarities calculated by the first similarity calculating unit. The first rating predicting unit predicts a rating, which is to be entered in an unfilled cell and which relates to the target user, using ratings, on items, of the k users extracted by the first neighbor data extracting unit. The item recommending unit extracts an item to be recommended to the target user from items having high ratings predicted by the first rating predicting unit and recommends the extracted item to the target user.

### SUMMARY

A technique determines an object to be recommended, using actions of users. Here, the actions of the users are, for example, ratings given by the users, and the object to be recommended is an item or a service. This technique aggregates ratings of many users (which are the actions of the users) and determines the object to be recommended.

However, this technology takes into account actions of many users uniformly, so the technology considers even an action of a user that is different from a tendency of an action of a user to whom the object is to be recommended. Since a tendency of an action reflects preferences of a user, an object that does not correspond to the preferences of the user may be presented.

Aspects of non-limiting embodiments of the present disclosure relate to providing an information processing apparatus and a non-transitory computer readable medium that can present an object corresponding to preferences of a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: search first action histories for second action histories similar to a specific action history of a second user to whom a recommendation is to be provided, in which each first action history represents objects which a first user corresponding to the first action history took a specific action for and each of which a degree of preference of the corresponding first user is given, and the specific action history represents objects which the second user took the specific action for; select an object to be recommended to the second user based on the degrees of preference for the respective objects which are given to the respective second action histories; and present the selected object.

### BRIEF DESCRIPTION OF THE DRAWINGS

Exemplary embodiment(s) of the present disclosure will be described in detail based on the following figures, wherein:

FIG. 1 is block diagram illustrating an example of a hardware configuration of an information processing apparatus according to an exemplary embodiment;

FIG. 2 is a block diagram illustrating an example of a functional configuration of the information processing apparatus according to the exemplary embodiment;

FIG. 3 is a diagram illustrating an example of an action history information database according to the exemplary embodiment;

FIG. 4 is a diagram illustrating examples of degrees of preference for each action history according to the exemplary embodiment;

FIG. 5 illustrates an example of recommendation degrees for each action history according to the exemplary embodiment;

FIG. 6 is a data flow diagram illustrating an example of a flow of a recommendation process according to the exemplary embodiment;

FIG. 7 is a flowchart of an example of the recommendation process of recommending an item, according to the exemplary embodiment; and

FIG. 8 is a flowchart of an example of an update process of updating parameter information, according to the exemplary embodiment.

### DETAILED DESCRIPTION

Hereinafter, an exemplary embodiment of the present disclosure will be described in detail with reference to the accompanying drawings. What will be now described in the present exemplary embodiment is an example in which the present disclosure is applied to an electronic commerce (EC) site.

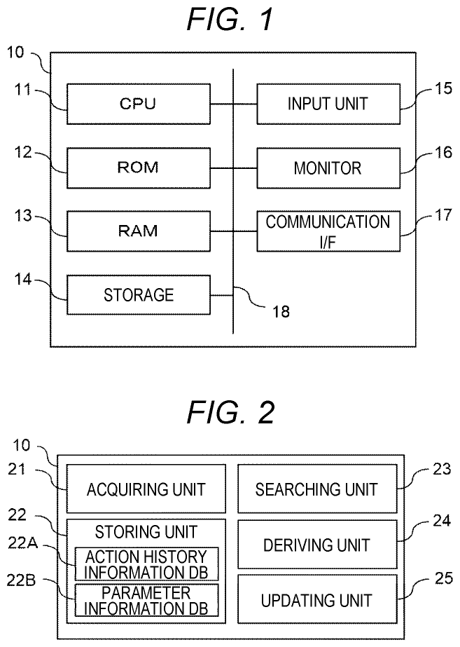

A configuration of an information processing apparatus 10 will be described with reference to FIG. 1. FIG. 1 is block diagram illustrating an example of a hardware configuration of the information processing apparatus 10 according to the present exemplary embodiment. The information processing apparatus 10 according to the present exemplary embodiment is, for example, a terminal device (such as a personal computer) or a server.

As illustrated in FIG. 1, the information processing apparatus 10 according to the present exemplary embodiment includes a central processing unit (CPU) 11, a read only memory (ROM) 12, a random access memory (RAM) 13, a storage 14, an input unit 15, a monitor 16, and a communication interface (communication I/F) 17. The CPU 11, the ROM 12, the RAM 13, the storage 14, the input unit 15, the monitor 16, and the communication FF 17 are connected to each other over a bus 18. Here, the CPU 11 is an example of a processor.

The CPU 11 supervises and controls the entire information processing apparatus 10. The ROM 12 stores various data and various programs including an information processing program which is used in the present exemplary embodiment. The RAM 13 is a memory that is used as a work area in executing the various programs. The CPU 11 loads the program stored in the ROM 12 onto the RAM 13 and executes the program to thereby perform a process of recommending an object such as an item. The storage 14 is, for example, a hard disk drive (HDD), a solid state drive (SSD), or a flash memory. The storage 14 may store a recommendation process program and an update process program. The input unit 15 is a mouse and a keyboard with which characters are input. The monitor 16 displays a generated text. The communication I/F 17 transmits and receives data.

Next, a functional configuration of the information processing apparatus 10 will be described with reference to FIG. 2. FIG. 2 is a block diagram illustrating an example of the functional configuration of the information processing apparatus 10 according to the present exemplary embodiment.

As illustrated in FIG. 2, the information processing apparatus 10 includes an acquiring unit 21, a storing unit 22, a searching unit 23, a deriving unit 24, and an updating unit 25. The CPU 11 executes the information processing program to thereby function as the acquiring unit 21, the storing unit 22, the searching unit 23, the deriving unit 24, and the updating unit 25.

The acquiring unit 21 acquires information representing objects for which a user took a specific action (hereinafter which will be referred to as an “action history”). Specifically, the acquiring unit 21 acquires (i) a specific action history of a user to whom an item is to be recommended and (ii) plural action histories stored in the storing unit 22 (which will be described later). What will now be described in the present exemplary embodiment is a case in which objects are items, and that action histories are information on items that users viewed at the EC site. It is noted that the present disclosure is not limited to this example. For example, information on music that users listened to may be stored as the action histories, or information on news articles that users viewed at a news site may be stored as the action histories. In this case, for music, the objects may be “music titles” representing titles of the music, and for the news site, the objects may be information for identifying the news articles. In the present exemplary embodiment, the specific action history is, for example, the latest action history. The latest action history is an action history including last n actions of the user where n is a positive integer. It is noted that the specific action history is not limited to the latest action history, but may be a history of actions of a user within a specific period of time. What will now be described is an example in which the specific action history is the latest action history.

The acquiring unit 21 acquires information on parameters for use in selecting an item to be recommended. The information on the parameters is stored in the storing unit 22 as will be described later, and hereinafter will be referred to as “parameter information”. Specifically, the acquiring unit 21 acquires a preference parameter and a weight value parameter. The term “preference parameter” refers to a parameter for setting degrees of preference for items relating to an action history. The term “weight value parameter” refers to a parameter relating to weight values corresponding to the degrees of preference.

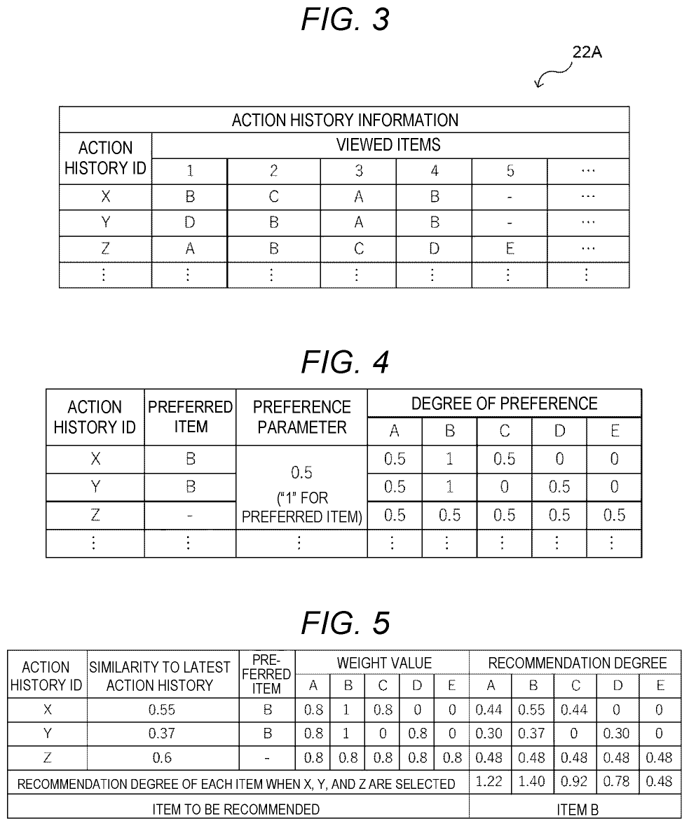

The storing unit 22 stores action history information in an action history information DB 22A. The term “action history information” refers to information representing a past action history of each user (hereinafter, which will be referred to as a “past action history”). For example, the action history information DB 22A illustrated in FIG. 3 stores, as the action history information, an action history identifier (ID) and items that the user viewed. Here, the term “action history ID” refers to information for identifying an action history of a user who viewed the EC site, and the phrase “items that the user viewed” refers to information on items which are arranged in order in which the user viewed.

The storing unit 22 stores the parameter information including the preference parameter and the weight value parameter in a parameter information DB 22B.

The searching unit 23 searches past action histories included in the action history information acquired by the acquiring unit 21 for action histories that are similar to the latest action history. Specifically, the searching unit 23 searches the past action histories for action histories similar to the latest action history, by deriving similarities between the past action histories and the latest action history, and selecting the predetermined number of action histories in a descending order of the similarity from the past action histories.

What will now be described is an example in which the similarities according to the present exemplary embodiment are cosine similarities. The cosine similarity is a technique to compare features using the features represented by vectors. The cosine similarity is in a range of −1 to 1. As the cosine similarity approaches 1, the cosine similarity represents that the two features are more similar to each other.

In the present exemplary embodiment, degrees of preference of a user relating to an action history are expressed by a vector. The degrees of preference relating to the latest action history and the degrees of preference relating to the past action histories are compared using the cosine similarity to search for an action history similar to the latest action history. In the present exemplary embodiment, the degree of preference for an item is set according to the number of times the user viewed the item.

For example, the latest action history represents “item A, item C, item A”. In this case, since the latest action history shows that the user viewed the item A plural times, the item A is set as an item having a high degree of preference (hereinafter, which is referred to as a “preferred item”). Degrees of preference relating to an action history are set in the following manner in order of the items A, B, C, D and E. That is, a degree of preference of “1” is set for a preferred item, a degree of preference of a preference parameter (for example, “0.5”) is set for an item that the user viewed, and a degree of preference of “0” is set for an item that the user did not view. Therefore, the degrees of preferences relating to the latest action history are expressed by a vector of [1, 0, 0.5, 0, 0]. Hereinafter, the set vector will be referred to as the “degrees of preference relating to the action history”, and an element set, for each item, in the vector will be referred to as the “degree of preference for the item”.

Similarly, the searching unit 23 sets a preferred item for each past action history and sets degrees of preference relating to each past action history using the preference parameter such that the degree of preference for the preferred item is large. In an example illustrated in FIG. 4, the searching unit 23 sets the degrees of preference relating to each action history using the action history information illustrated in FIG. 3 and the preference parameter.

The searching unit 23 derives similarities using the degrees of preference relating to the latest action history and the degrees of preference relating to the past action histories, and selects the predetermined number of action histories from the past action histories in descending order of similarity.

The deriving unit 24 derives a degree to which each item is to be recommended (hereinafter, which will be referred to as a “recommendation degrees”) using the similarity relating to each selected action history and weight values. The deriving unit 24 aggregates the derived recommendation degrees of each item, and selects an item having the largest recommendation degree as an item to be recommended. The recommendation degree according to the present exemplary embodiment is expressed by the following equation (1).

score(i,s)=Σ_{n∈N}SIM(s,n)·vₙ(i) (1)

where score(i, s) is a recommendation degree of each item, “i” is an element representing each item, “s” is an element representing the latest action history, “n” is an element representing each past action history, and N is a set of the selected past action histories. SIM(s, n) is a similarity between the degrees of preference relating to the latest action history and the degrees of preference relating to the past action history, and vn is a weight value set for each item and each past action history.

As illustrated in the equation (1), the recommendation degree of each item is derived by summing values each obtained by multiplying a similarity relating to (i) the latest action history and (ii) a respective one of the past action histories by a weight value set for (i) the item and (ii) the respective one of the past action histories.

The weight value according to the present exemplary embodiment is set for each item in accordance with the degrees of preference relating to the past action history. Specifically, the weight values are set in the following manner in order of the items A, B, C, D, and E. That is, a weight value of “1” is set for a preferred item, a weight value of a weight value parameter (for example, 0.8) is set for an item that the user viewed, and a weight value of “0” is set for an item that the user did not view.

For example, as illustrated in FIG. 5, an action history ID “X” has a preferred product of an “item B”. Thus, a weight value of “1” is set for the preferred item B, a weight value of “0.8” is set for the items A and C which the user viewed, a weight value of “0” is set for the items D and E which the user did not view. Accordingly, as illustrated in FIG. 5, the weight values relating to the action history ID “X” are expressed by a vector of [0.8, 1, 0.8, 0, 0].

The deriving unit 24 applies the similarities relating to the selected action histories and the weight values to the equation (1) to derive the recommendation degrees, sums the recommendation degrees for each item, and select an item having the largest recommendation degree as an item to be recommended.

In the example illustrated in FIG. 5, action histories having action history IDs “X”, “Y” and “Z” are selected by the searching unit 23. In this case, the deriving unit 24 multiplies the similarity relating to each action history by the weight value for each item to derive a recommendation degree relating to each action history for each item. The deriving unit 24 sums the derived recommendation degrees for each item to derive a recommendation degree of each item, selects the item B having the largest recommendation degree of “1.40”, and outputs the item B as an item to be recommended.

The updating unit 25 updates the parameter information including the preference parameter and the weight value parameter.

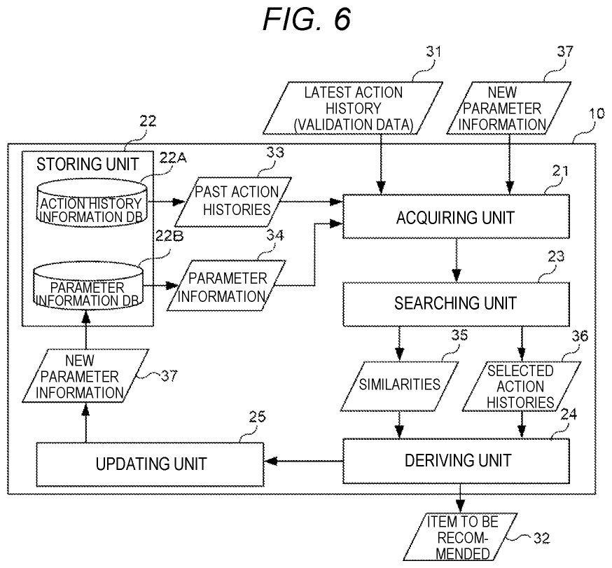

Next, before description on an operation of the information processing apparatus 10, a technique of selecting an item to be recommended according to the present exemplary embodiment will be described with reference to FIG. 6. FIG. 6 is a data flow diagram illustrating an example of a flow of a recommendation process according to the present exemplary embodiment.

In an example illustrated in FIG. 6, the information processing apparatus 10 selects an item 32 to be recommended to a user, using the latest action history 31.

The acquiring unit 21 acquires the latest action history 31 of the user. The acquiring unit 21 further acquires, from the storing unit 22, (i) past action histories 33 as the action history information and (ii) parameter information 34 including a preference parameter and a weight value parameter.

The searching unit 23 sets vectors each of which represents degrees of preference relating to a respective one of the action histories 31 and 33, using the acquired latest action history 31, the acquired past action histories 33, and the preference parameter included in the acquired parameter information 34. The searching unit 23 derives similarities 35 relating to the latest action history 31 and the past action histories 33 using the set degrees of preference relating to the respective action histories 31 and 33, and selects the predetermined number of action histories from the past action histories 33 in descending order of the similarity 35.

The deriving unit 24 sets weight values using the past action histories 33 and the weight value parameter included in the parameter information 34, and multiplies the similarities relating to the selected action histories 36 by the weight values to derive a recommendation degree for each item and each selected action history 36. The deriving unit 24 aggregates the derived recommendation degrees for each item to derive a recommendation degree of each item, and outputs an item having the largest recommendation degree as the item 32 to be recommended.

The updating unit 25 updates the parameter information DB 22B.

For example, if the latest action history 31 (which is validation data) is input in a validation process, the deriving unit 24 derives recommendation degrees using the latest action history 31 (which is the validation data), the similarities relating to the past action histories 33, and the parameter information 34. Here, the updating unit 25 receives new parameter information 37 from the user and stores the received new parameter information 37 in the parameter information DB 22B of the storing unit 22 for update.

If the parameter information DB 22B is updated by the updating unit 25, the deriving unit 24 derives the recommendation degrees again using the new parameter information 37, the latest action history 31 (which is the validation data), and the similarities relating to the past action histories 33.

The information processing apparatus 10 repeats the above process until the user stops inputting the new parameter information 37, updates the parameter information DB 22B, and derives the recommendation degrees.

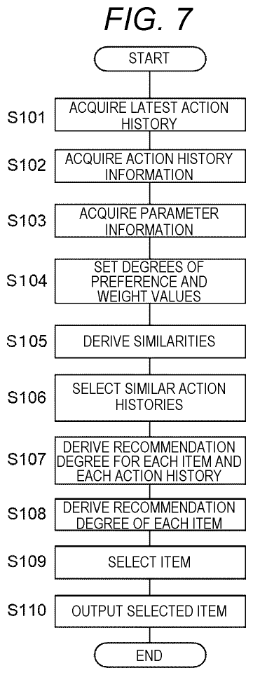

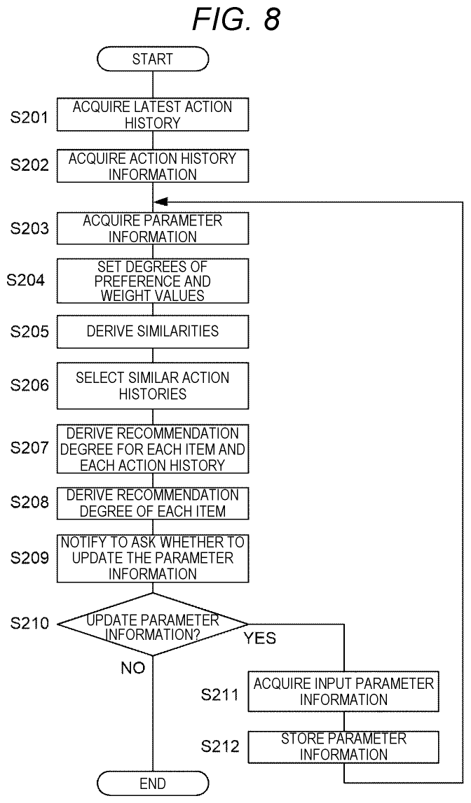

Next, the operation of the information processing apparatus 10 according to the present exemplary embodiment will be described with reference to FIGS. 7 and 8. FIG. 7 is a flowchart of an example of a recommendation process of recommending an item, according to the present exemplary embodiment. The CPU 11 reads the recommendation process program from the ROM 12 or the storage 14 and executes the recommendation process program, so that the recommendation process illustrated in FIG. 7 is executed. For example, in response to the user inputting the latest action history, the recommendation process illustrated in FIG. 7 is executed.

In step S101, the CPU 11 acquires input latest action history.

In step S102, the CPU 11 acquires past action histories from the stored action history information.

In step S103, the CPU 11 acquires a preference parameter and a weight value parameter included in the parameter information.

In step S104, the CPU 11 sets (i) degrees of preference relating to the latest action history and the past action histories and (ii) weight values, using the acquired latest action history, the acquired past action histories, and the acquired parameter information.

In step S105, the CPU 11 derives similarities relating to the latest action history and the past action histories, using the derived degrees of preference relating to the latest action history and the past action histories.

In step S106, the CPU 11 selects action histories similar to the latest action history from the past action histories, using the derived similarities.

In step S107, the CPU 11 derives a recommendation degree for each item and each selected past action history, using the similarities and the weight values which relate to the selected past action history.

In step S108, the CPU 11 aggregates the derived recommendation degrees for each item to derive a recommendation degree of each item.

In step S109, the CPU 11 selects an item having the largest recommendation degree as the item to be recommended.

In step S110, the CPU 11 outputs the item to be recommended.

FIG. 8 is a flowchart of an example of an update process of updating the parameter information according to the present exemplary embodiment. The CPU 11 reads the update process program from the ROM 12 or the storage 14 and executes the update process program, so that the update process illustrated in FIG. 8 is executed. For example, in response to the user inputting an action history (which is validation data), the update process illustrated in FIG. 8 is executed.

In step S201, the CPU 11 acquires the latest action history which is input validation data.

In step S202, the CPU 11 acquires past action histories from the stored action history information.

In step S203, the CPU 11 acquires a preference parameter and a weight value parameter included in the parameter information.

In step S204, the CPU 11 sets (i) degrees of preference relating to the latest action history (which is the validation data) and the past action histories and (ii) weight values, using the acquired latest action history (which is the validation data), the acquired past action histories, and the acquired parameter information.

In step S205, the CPU 11 derives similarities relating to the latest action history (which is the validation data) and the past action histories, using the degrees of preference relating to the latest action history (which is the validation data) and the past action histories.

In step S206, the CPU 11 selects action histories similar to the latest action history (which is the validation data) from the past action histories, using the derived similarities.

In step S207, the CPU 11 derives a recommendation degree for each item and each selected past action history, using the similarities and the weight values which relate to the selected past action history.

In step S208, the CPU 11 aggregates the derived recommendation degrees for each item to derive a recommendation degree of each item.

In step S209, the CPU 11 sends a notification to the user to ask whether to update the parameter information.

In step S210, the CPU 11 determines if the user has input new parameter information to determine whether to update the parameter information. If the user has input the new parameter information and the parameter information is to be updated (step S210: YES), the CPU 11 proceeds to step S211. On the other hand, if the user has input no new parameter information and the parameter information is not to be updated (step S210: NO), the CPU 11 terminates the series of processes.

In step S211, the CPU 11 acquires the new parameter information input from the user.

In step S212, the CPU 11 stores the acquired new parameter information in the parameter information DB 22B of the storing unit 22 as the parameter information, and proceeds to step S203.

As described above, according to the present exemplary embodiment, an item to be recommended is selected based on the latest action history in consideration of the degrees of preference relating to the latest action history and the degrees of preference relating to the past action histories. Accordingly, an object corresponding to the preferences of the user is presented.

In the present exemplary embodiment, what has been described is the example in which the preference parameter and the weight value parameter are set for each item in accordance with whether the item is a preferred item. It is noted that the present disclosure is not limited to this example. An extent to which the user prefers each item may be determined, and the preference parameter and the weight value parameter may be set in accordance with the determined extent to which the user prefers. For example, the extent to which the user prefers each item may be determined in accordance with the number of times the user viewed the item, and the preference parameter and the weight value parameter may be set.

For example, if the number of times the user viewed an item in question is one, a value of “0” is set; if the number of times the user viewed the item in question is two, a value of “1” is set; if the number of times the user viewed the item in question is three, a value of “2” is set; and if the number of times the user viewed the item in question is four or more, a value of “3” is set. The degree of preference is derived by raising the preference parameter to the power of the number of times the user viewed the item in question. For example, the latest action history is “item A, item B, item A, item C, item A, item B” and the preference parameter is “1.2”. In this case, the degree of preference for the item A is set to 1.44 which is obtained by raising 1.2 to the power of 2 (which is the value corresponding to the number of times the user viewed the item A). Similarly, the degree of preference for the item B is set to 1.2 which is obtained by raising 1.2 to the power of 1 (which is the value corresponding to the number of times the user viewed the item B). Also, the degree of preference for the item C is set to 1 which is obtained by raising 1.2 to the power of 0 (which is the value corresponding to the number of times the user viewed the item C). Accordingly, the degrees of preference relating to the latest action history is [1.44, 1.2, 1, 0, 0]. A degree of preference for an item that the user did not view is set to 0.

This results in that as the number of times the user views an item increases, a degree of preference for the item increases. In other words, the degree of preference for the item increases in accordance with a level of the extent to which the user prefers the item. In the above-described exemplary embodiment, what has been described is the example in which the degree of preference is derived by raising the preference parameter to the power of the set value. It is noted that the present disclosure is not limited to this example. The weight value may be derived by raising the weight value parameter to the power of the set value. Alternatively, instead of exponential, the degree of preference may be derived by addition or multiplication.

In the present exemplary embodiment, what has been described is the example in which the extent to which the user prefers an item is determined in accordance with the number of time the user viewed the item, to set the degree of preference. It is noted that the present disclosure is not limited to this example. The extent to which the user prefers an item may be determined in accordance with an action that the user took for the item, to set the degree of preference. For example, if the user viewed an item, a value of “1” may be set for the item; if the user bookmarked the item, a value of “2” may be set for the item; and if the user purchased the item, a value of “3” may be set for the item. Then, the degree of preference for the item may be derived by raising the preference parameter to the power of the set value. Alternatively, the degree of preference may be set in accordance with a period of time for which the user viewed the item or the number of times the user repeatedly viewed the item.

In the present exemplary embodiment, what has been described is the example in which the information processing apparatus 10 is applied to the EC site. It is noted that the present disclosure is not limited to this example. The information processing apparatus 10 may be applied to a video sharing site. Alternatively, the information processing apparatus 10 may be mounted on a reproduction device that reproduces video and music. For example, in a case in which the information processing apparatus 10 is applied to a video sharing site and mounted on a reproduction device, a degree of preference may be set in accordance with the number of views and a viewing time, or may be set in accordance with a count as to how many times video and music were viewed till the end and a count as to how many times video and music were not viewed till the end. The degree of preference may be set in accordance with a count as to how many times video and music were repeatedly viewed.

In the present exemplary embodiment, the parameter information including the preference parameter and the weight value parameter are stored in advance. It is noted that the present disclosure is not limited to this example. For example, the degree of preference for an item and a weight value for the item are set in accordance with the number of times the user viewed the item. Alternatively, the degree of preferences and the weight values may be normalized using the number of times the user viewed such that a degree of preference for an item having the largest number of times the user viewed and a weight value for the item having the largest number of times the user viewed are 1. The number of times the user viewed an item may be set as the degree of preference for the item and the weight value for the item. In the present exemplary embodiment, what has been described is the example in which the preference parameter and the weight value parameter are applied to values relating to an item other than a preferred item. It is noted that the present disclosure is not limited to this example. The preference parameter may be applied to the degree of preference for the preferred item. Any configuration may be employed if as the number of times the user viewed an item increases, a value set for the item increases.

The similarity according to the present exemplary embodiment is the cosine similarity. It is noted that the present disclosure is not limited to this example. The similarity may be a similarity using a Euclid distance or may be a similarity using a Jaccard index.

Also, in the present exemplary embodiment, the recommendation degree is derived using the preference parameter and the weight value parameter. It is noted that the present disclosure is not limited to this example. A recommendation degree may be derived using only one of the preference parameter and the weight value parameter.

The present disclosure has been described above using the exemplary embodiment. It is noted that the present disclosure is not limited to the scope described in the exemplary embodiment. Various modifications or improvements may be made to the exemplary embodiment without departing from the spirit and scope of the present disclosure. The modified or improved exemplary embodiment is still included in the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the present exemplary embodiment, the information processing program is installed in the storage 14. It is noted that the present disclosure is not limited to this example. The information processing program according to the present exemplary embodiment may be provided in a form that the information processing program is stored in a computer readable storage medium. For example, the information processing program according to the present disclosure may be provided in a form that the information processing program is recorded in an optical disc such as a Compact Disc (CD) ROM and a Digital Versatile Disk (DVD) ROM. The information processing program according to the present disclosure may be provided in a form that the information processing program is recorded in a semiconductor memory such as a universal serial bus (USB) memory and a memory card. Further, the information processing program according to the present exemplary embodiment may be acquired from an external device over a communication line connected to the communication I/F 17.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
search first action histories for second action histories similar to a specific action history of a second user to whom a recommendation is to be provided, wherein
each first action history represents objects which a first user corresponding to the first action history took a specific action for and each of which a degree of preference of the corresponding first user is given, and
the specific action history represents objects which the second user took the specific action for;
select an object to be recommended to the second user based on the degrees of preference for the respective objects which are given to the respective second action histories; and
present the selected object.

2. The information processing apparatus according to claim 1, wherein
the processor is configured to:
give the degrees of preference to the specific action history; and
search the first action histories for the second action histories similar to the specific action history, using the degrees of preference given to (i) the specific action history and (ii) the first action histories.

3. The information processing apparatus according to claim 2, wherein
as the degree of preference for the object increases, a value given to the first action history increases.

4. The information processing apparatus according to claim 1, wherein
the processor is configured to:
derive similarities representing degrees to which the specific action history and the first action histories are similar; and
select the object to be recommended, using the similarities and weight values corresponding to the degrees of preference.

5. The information processing apparatus according to claim 2, wherein
the processor is configured to:
derive similarities representing degrees to which the specific action history and the first action histories are similar; and
select the object to be recommended, using the similarities and weight values corresponding to the degrees of preference.

6. The information processing apparatus according to claim 3, wherein
the processor is configured to:
derive similarities representing degrees to which the specific action history and the first action histories are similar; and
select the object to be recommended, using the similarities and weight values corresponding to the degrees of preference.

7. The information processing apparatus according to claim 4, wherein as the degree of preference for the object increases, the weight value increases.

8. The information processing apparatus according to claim 5, wherein as the degree of preference for the object increases, the weight value increases.

9. The information processing apparatus according to claim 6, wherein as the degree of preference for the object increases, the weight value increases.

10. The information processing apparatus according to claim 1, wherein
the processor is configured to derive the degrees of preference based on information on the specific action that the first users took for the objects.

11. The information processing apparatus according to claim 2, wherein
the processor is configured to derive the degrees of preference based on information on the specific action taken for the objects.

12. The information processing apparatus according to claim 3, wherein
the processor is configured to derive the degrees of preference based on information on the specific action taken for the objects.

13. The information processing apparatus according to claim 4, wherein
the processor is configured to derive the degrees of preference based on information on the specific action taken for the objects.

14. The information processing apparatus according to claim 5, wherein
the processor is configured to derive the degrees of preference based on information on the specific action taken for the objects.

15. The information processing apparatus according to claim 6, wherein
the processor is configured to derive the degrees of preference based on information on the specific action taken for the objects.

16. The information processing apparatus according to claim 1, wherein the first users include the second user.

17. The information processing apparatus according to claim 1, wherein
the processor is configured to:
derive a recommendation degree representing a degree to which each item is to be recommended, based on the degrees of preference for the item which are given to the second action histories; and
selecting the object to be recommended to the second user, based on the degrees of preference for the respective objects which are given to the second action histories, respectively.

18. A non-transitory computer readable medium storing a program that causes a computer to execute information processing, the information processing comprising:
searching first action histories for second action histories similar to a specific action history of a second user, wherein
each first action history represents objects which a first user corresponding to the first action history took a specific action for and each of which a degree of preference of the corresponding first user is given, and
the specific action history represents objects which a second user to whom a recommendation is to be provided took the specific action for;
selecting an object to be recommended based on the degrees of preference for the respective objects which are given to the respective second action histories; and
presenting the selected object.

19. The non-transitory computer readable medium according to claim 18, wherein
the first users include the second user.

20. An information processing apparatus comprising:
a processor configured to:
acquire a plurality of action histories, wherein each action history represents objects which a user corresponding to the action history took a specific action for and each of which a degree of preference of the corresponding user is given;
select a plurality of action histories which are similar to at least one action history of a target user from the acquired plurality of action histories;
select an object to be recommended to the target user based on the degrees of preference for the respective objects which are given to the respective selected action histories; and
present the selected object to the target user.
